(19) United States
(12) Patent Application Publication
(10) Pub. No.: US 2012/0287645 A1
(43) Pub. Date: Nov. 15, 2012

(54) DISPLAY APPARATUS

(76) Inventors: Junhwan Ju, Seoul (KR); DeugJin Lee, Seoul (KR); Taeyong Kim, Seoul (KR)

(21) Appl. No.: 13/514,093

(22) PCT Filed: Nov. 23, 2010
(86) PCT No.: PCT/KR2010/008267

§ 371 Date: Jun. 6, 2012

(30) Foreign Application Priority Data
Dec. 8, 2009 (KR) 10-2009-0121022
Jan. 22, 2010 (KR) 10-2010-0005863

(51) Int. Cl. F21V 21/00; F21V 7/00

(52) U.S. Cl. 362/296.01; 362/382

(57) ABSTRACT

There is provided a display apparatus. The apparatus includes: a display module; a front panel disposed on a front surface of the display module; a light shielding layer disposed on the outer peripheral area of the front panel; a pattern layer of which at least a part is overlapped with the light shielding layer; and a light source, wherein a pattern formed on the pattern layer emits light by using light provided from the light source.

### TECHNICAL FIELD

The present invention relates to a display apparatus.

### BACKGROUND ART

In general, various electronic apparatuses such as a mobile communication terminal, a digital camera, a notebook, a monitor, a TV, and the like include a display apparatus for displaying an image.

With the development of an information society, a requirement for a display apparatus is also being increased in various forms. Various display apparatuses such as a liquid crystal display (LCD), a plasma display panel (PDP), an electro luminescent display (ELD), a vacuum fluorescent display (VFD), and the like have recently been researched and used by complying with the requirement.

### DISCLOSURE OF INVENTION

### Technical Problem

There is an object of the present invention to improve the appearance of a display apparatus.

### Solution to Problem

An exemplary embodiment of the present invention provides a display apparatus that includes: a display module; a front panel disposed on a front surface of the display module; a light shielding layer disposed on the outer peripheral area of the front panel; a pattern layer of which at least a part is overlapped with the light shielding layer; and a light source, wherein a pattern formed on the pattern layer emits light by using light provided from the light source.

Another exemplary embodiment of the present invention provides a display apparatus that includes: a display module; a front panel disposed on a front surface of the display module; a transparent film disposed on a front surface of the front panel; a light shielding layer formed on the outer peripheral area of the transparent film; a pattern layer formed on one surface of the transparent film and including formed at a position overlapped with the light shielding layer; and a light source, wherein a pattern formed on the pattern layer emits light by using light provided from the light source.

### BRIEF DESCRIPTION OF DRAWINGS

FIG. 1 is a diagram schematically illustrating a display region and a non-display region of a display apparatus;

FIG. 2 is a cross-sectional view illustrating an exemplary embodiment of a configuration of a display apparatus according to a first exemplary embodiment of the present invention;

FIG. 3 is a cross-sectional view illustrating an exemplary embodiment of a configuration of a display apparatus according to a second exemplary embodiment of the present invention;

FIG. 4 is a plan view illustrating an exemplary embodiment of a configuration of a pattern layer where a transparent film is formed;

FIG. 5 is a cross-sectional view for describing an exemplary embodiment of a method for emitting a pattern;

FIG. 6 is a cross-sectional view illustrating an exemplary embodiment of a configuration of a display apparatus according to a third exemplary embodiment of the present invention;

FIG. 7 is a cross-sectional view illustrating an exemplary embodiment of a configuration of a display apparatus according to a fourth exemplary embodiment of the present invention;

FIGS. 8 to 10 are plan views schematically illustrating exemplary embodiments of a front shape of a display apparatus viewed from the side of a user;

FIG. 11 is a perspective view illustrating a configuration of a display apparatus according to an exemplary embodiment of the present invention;

FIG. 12 is a perspective view and a cross-sectional view illustrating a configuration of a front panel provided in a display apparatus according to an exemplary embodiment of the present invention;

FIG. 13 is a cross-sectional view illustrating an exemplary embodiment of a cross-sectional configuration of a display apparatus;

FIG. 14 illustrates diagrams of an exemplary embodiment of a configuration of a mounting member of a display apparatus;

FIG. 15 is a perspective view illustrating a state in which a mounting member is mounted on a front panel of a display apparatus;

FIG. 16 is a cross-sectional view illustrating a first exemplary embodiment of a cross-sectional configuration of a periphery of a display apparatus;

FIG. 17 is a cross-sectional view illustrating a second exemplary embodiment of a cross-sectional configuration of a periphery of a display apparatus;

FIG. 18 is a cross-sectional view illustrating a third exemplary embodiment of a cross-sectional configuration of a periphery of a display apparatus;

FIG. 19 is an external perspective view of a display apparatus according to an exemplary embodiment of the present invention; and

FIGS. 20 to 22 are cross-sectional views taken along line I-I of FIG. 19.

### BEST MODE FOR CARRYING OUT THE INVENTION

Hereinafter, a display apparatus according to an exemplary embodiment of the present invention will be described in detail with reference to the accompanying drawings.

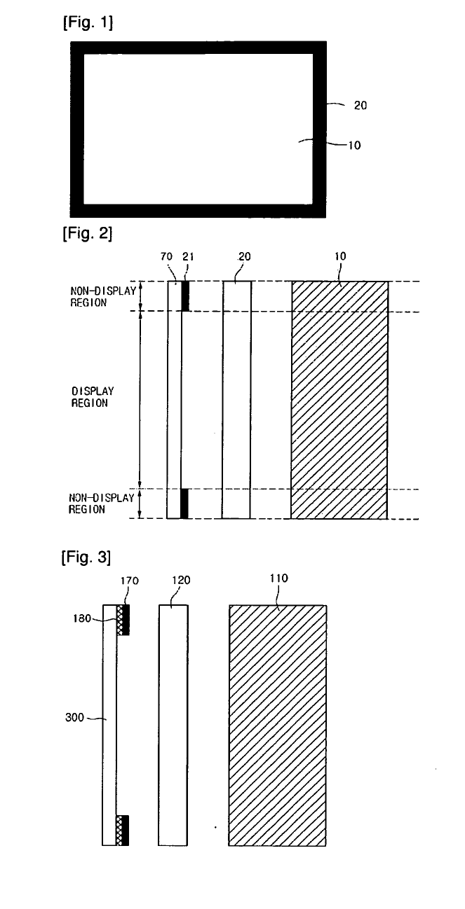

FIG. 1 is a diagram schematically illustrating a display region and a non-display region of a display apparatus and showing a shape of the display apparatus when viewed from a front surface, that is, a user.

Referring to FIG. 1, the display apparatus may include a display region 10 where an image is displayed and a non-display region 20 where the image is not displayed. The non-display region 20 is formed on the outer peripheral area of the display apparatus to surround the display region 10. A light shielding layer may be formed in the non-display region 20.

The light shielding layer formed in the non-display region 20 may shield light that passes through the outer peripheral area of the display apparatus, as a result, a structure provided in the outer peripheral area of the display apparatus in addition to an image to be displayed may not be viewed from the side of a user.

The light shielding layer formed in the non-display region 20 may have a black color, for example, may be a black layer printed with the black color in order to effectively shield light. As a result, the non-display region 20 of the display apparatus may have the black color from the side of the user.

Meanwhile, when the display apparatus is turned off, a part of the display region 10 where the image is not displayed shows the black color similar to the non-display region 20. However, in this case, external light incident from the outside may be reflected, absorbed, or scattered differently in the display region 10 and the non-display region 20.

For example, in the display region 10, the external light may be partially reflected by a display panel provided therein and in the non-display region 20 where the black layer is printed, most of light may be absorbed. As a result, when power is off, visual heterogeneity may be generated between the display region 10 and the non-display region 20 of the display apparatus. The visual heterogeneity may clearly be expressed on, particularly, a boundary between the display region 10 and the non-display region 20 and may deteriorate design characteristics of the display apparatus.

FIG. 2 is a cross-sectional view illustrating an exemplary embodiment of a configuration of a display apparatus according to a first exemplary embodiment of the present invention. The shown the display apparatus may include a display module 110, a front panel 120, a light shielding layer 170, and a pattern layer 180.

Referring to FIG. 2, the display module 110 displays an image by emitting light toward the front surface where the front panel 120 is disposed. For example, the display module 110 may be a liquid crystal display module and in this case, the display module 110 may include a liquid crystal panel (not shown) and a backlight unit (not shown). The liquid crystal panel (not shown) may display an image by using light provided from the backlight unit (not shown) and for this, the liquid crystal panel (not shown) may include a liquid crystal layer, and a TFT substrate and a color filter substrate that face each other with the liquid crystal layer interposed therebetween.

However, the exemplary embodiments of the present invention are not limited to the liquid crystal display and may be applied to various other display apparatuses such as a plasma display panel (PDP), an electro luminescent display (ELD), vacuum fluorescent display (VFD), and the like.

The front panel 120 is spaced apart from the display module 110 by a predetermined gap and disposed on the front surface of the display module 110 to protect the display module 110 from an external impact and transmits light emitted from the display module 110 to allow the image displayed in the display module 110 to be viewed to the outside.

For example, the front panel 120 may be made of a plastic material such as acrylic, and the like or a glass material that has impact-resistance and light transmittance.

As shown in FIG. 2, the front panel 120 may include the display region through the light from the display module 110 is transmitted to display the image and a non-display region surrounding the display region and the light shielding layer 170 shielding the light may be formed in the non-display region.

According to the exemplary embodiment of the present invention, the pattern layer 180 may be formed between the front panel 120 and the light shielding layer 170. That is, the light shielding layer 170 and the pattern layer 180 may be overlapped with each other in the non-display region of the front panel 120.

The pattern layer 180 may be formed by printing a pattern having a predetermined shape and a predetermined color onto one surface of the front panel 120, i.e., the rear surface of the front panel 120.

More specifically, a pattern having a predetermined shape is formed on a rear surface of the front panel 120 by using electroluminescence (EL) printing or a doparo function and thereafter, the formed pattern is applied with a color to form the pattern layer 180.

Meanwhile, the display apparatus according to the exemplary embodiment of the present invention may further include a light source (not shown) for providing light to the pattern layer 180.

For example, the light source may be disposed on a lateral surface of the pattern layer 180. The pattern formed on the pattern layer 180 emits light by the light emitted from the light source, as a result, a shape and a color corresponding to the printed pattern may be shown on the entire surface of the display apparatus.

According to the exemplary embodiment of the present invention, the pattern formed on the pattern layer 180 may emit light for a predetermined time after power is supplied to the display apparatus, i.e., a stand-by time of 4 to 5 seconds until an image is displayed on a screen after the display apparatus is turned on.

As a result, the user may perceive that a pattern having a predetermined shape and a predetermined color may be display in the outer peripheral area, i.e., the non-display region for the stand-by time of the display apparatus, as a result, it is possible to reduce user s boredom for the stand-by time while improving the appearance design of the display apparatus.

For this, the light source operates for the predetermined time, i.e., the stand-by time after the power is supplied to the display apparatus to emit light toward the pattern layer 180.

Since the operation of the light source and the resulting emission of the pattern are just the exemplary embodiment of the present invention, the present invention is not limited thereto.

For example, the pattern formed on the pattern layer 180 emits light even when the power is not supplied to the display apparatus, that is, the display apparatus is turned off to be viewed to the user. For this, the light source receives stand-by power usable when the display apparatus is turned off to transmit the light to the pattern layer 180.

Meanwhile, since the configuration of the display apparatus shown in FIG. 2 is just the exemplary embodiment of the present invention, the present invention is not limited thereto.

That is, unlike shown in FIG. 1, at least one of the light shielding layer 170 and the pattern layer 180 may be fixed to a structure other than the front panel 120.

FIG. 3 is a cross-sectional view illustrating an exemplary embodiment of a configuration of a display apparatus according to a second exemplary embodiment of the present invention. The same components as described with reference to FIGS. 1 and 2 in the configuration of the display apparatus shown in FIG. 3 will not be described below.

Referring to FIG. 3, the display apparatus according to the exemplary embodiment of the present invention may further include a transparent film 300 disposed on the front surface of the front panel 120 and the front film 300 may be made of polyethylene terephthalate (PET), and the like.

Further, the transparent film 300 may include one or more functional layer for improving optical characteristics of a display image.

Meanwhile, the pattern layer 180 may be formed on one surface of the transparent film 300, i.e., a rear surface of the transparent film 300 and the light shielding layer 170 may also be formed on one surface of the transparent film 300.

In this case, as shown in FIG. 3, the pattern layer 180 is formed by printing a pattern having a predetermined shape and a predetermined color on the rear surface of the transparent film 300 and a black layer is printed on the rear surface of the transparent film 300 on which the pattern layer 180 is formed to form the light shielding layer 170.

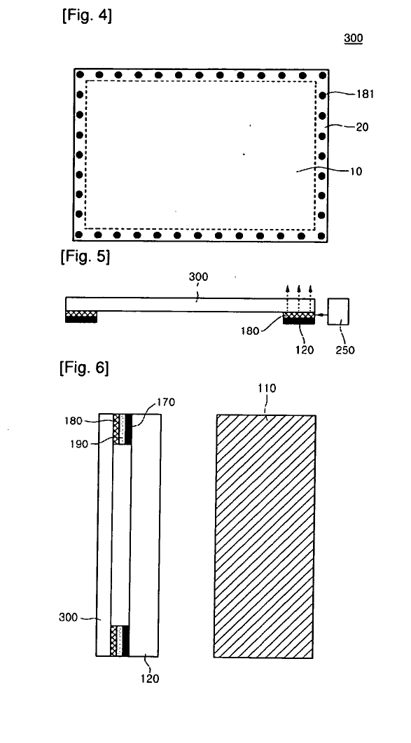

Referring to FIG. 4, a pattern 181 having a predetermined shape is formed on a part of the rear surface of the transparent film 300 corresponding to the non-display region 20 by using the EL printing or doparo function and thereafter, a color is printed on the formed pattern 181 to form the pattern layer 180.

More specifically, a pattern having a desired shape is formed on a print copper plate and thereafter, the pattern 181 of the same shape as the pattern formed on the print copper plate may be formed on the transparent film 300 by using a roll, and the like.

Thereafter, a predetermined color is printed on the transparent film 300 on which the pattern 181 is formed to form the pattern layer 180.

Meanwhile, the shapes, colors, or number of the patterns 181 printed on the transparent film 300 may be changeable.

FIG. 5 is a cross-sectional view for describing an exemplary embodiment of a method for emitting a pattern. The same components as described with reference to FIGS. 1 to 4 in the configuration of the display apparatus shown in FIG. 5 will not be described below.

Referring to FIG. 5, a light source 250 may be disposed on the lateral surface of the pattern layer 180 or the transparent film 300 on which the pattern layer 180 is formed.

Light emitted from the light source 250 is incident into the pattern layer 180 or the transparent film 300 on which the pattern layer 180 is formed and the pattern 181 formed on the pattern layer 180 emits light upwards by the incident light.

The shape and color corresponding to the pattern 181 are shown on the entire surface of the display apparatus by the emission of the pattern 181 to be visually perceived by the user.

The light source 250 may be any one of a light emitting diode (LED) chip or a light emitting diode package having at least one light emitting diode chip. In the exemplary embodiment, the case in which the light emitting diode package is provided as the light source 250 will be described as an example.

Meanwhile, the LED package configuring the light source 250 may be classified into a top view type and a side view type in accordance with a direction in which a light emitting surface faces. The light source 250 according to the exemplary embodiment of the present invention may be configured by using at least one of the top view type LED package in which the light emitting surface is the top of the LED package (for example, light is emitted in the upper direction or vertical direction) and the side view type LED package in which the light emitting surface is the side of the LED package (for example, light is emitted in the lateral direction or horizontal direction).

For example, in the case in which the LED package configuring the light source 250 is the side view type, the light emitted from the light source 250 may be side-incident into the pattern layer 180 or the transparent film 300 on which the pattern layer 180 is formed as shown in FIG. 5.

As another exemplary embodiment of the present invention, in the case in which the

LED package configuring the light source 250 is the top view type, the light source 250 may be disposed below the pattern layer 180 unlike shown in FIG. 5.

Further, the light source 250 may be configured by a colored LED or a white LED emitting at least one color of colors of red, blue, green, and the like. Further, the colored LED may include at least one of a red LED, a blue LED, and a green LED. The layout and emission light of the light emitting diode may be modified within the scope of the exemplary embodiment.

FIG. 6 is a cross-sectional view illustrating an exemplary embodiment of a configuration of a display apparatus according to a third exemplary embodiment of the present invention. The same components as described with reference to FIGS. 1 to 5 in the configuration of the display apparatus shown in FIG. 6 will not be described below.

Referring to FIG. 6, a reflection layer 190 may be formed on one surface of the transparent film 300, i.e., the rear surface of the transparent film 300 to be overlapped with the light shielding layer 170. That is, the light shielding layer 170 and the reflection layer 190 may be overlapped with each other in the non-display region of the transparent film 300.

The reflection layer 190 may be a metal thin film layer which is formed by depositing metal, i.e., nickel (Ni) or aluminum (Al) on one surface of the transparent film 300.

The reflection layer 190 has both reflectance and transmittance for light by characteristics of metal and characteristics of a thin film. As a result, the reflection layer 190 may partially reflect the external light incident from the outside and partially transmit the light.

Further, the pattern layer 180 may be positioned between the reflection layer 190 and the transparent film 300. More specifically, as shown in FIG. 5, the pattern layer 180 is formed on the rear surface of the transparent film 300 and the reflection layer 190 and the light shielding layer 170 may be laminated on the pattern layer 180 in sequence.

As described above, as the reflection layer 190 has both light reflectance and transmittance, a part of the external light incident into the non-display region is reflected on the reflection layer 190 to be emitted toward the front surface, that is, the side of the user again and the rest part of external light incident into the non-display region may be transmitted through the reflection layer 190 and absorbed in the light shielding pattern 170.

By the above configuration, the reflection of the external light generated in the display region of the display apparatus may be generated even on the non-display region, more specifically, the reflection layer 190 formed in the non-display region.

Further, a part of the external light incident into the non-display region is transmitted through the reflection layer 190 to be absorbed in the light shielding pattern 170, i.e., the printed black layer. Therefore, the external light generated in the display region is also absorbed in the non-display region and as a result, both the display region and the non-display region may show the black color.

As a result, when the display apparatus is viewed from the front surface, a similar visual reflection effect may be acquired in the display region and the non-display region, thereby reducing the visual heterogeneity between the display region and the non-display region.

The thickness of the reflection layer 190 may be smaller than each of the thickness of the shielding layer 170, the thickness of the front panel 120, and the thickness of the transparent film 300.

Meanwhile, as the thickness of the reflection layer 190 increases, the reflectance of the reflection layer 190 increases, but the transmittance decreases, such that the non-display may be shown excessively bright and as the thickness of the reflection layer 190 decreases, the transmittance of the reflection layer 190 increases, but the reflectance may be excessively reduced.

Accordingly, the reflection layer 190 has reflectance and transmittance for light, such that the thickness of the reflection layer 190 is preferably in the range of 0.005 to 0.1 mm and the transmittance of the reflection layer 190 is preferably in the range of 30 to 50% so that the non-display region shows the black color and the user feels the reflectance effect when viewed from the side of the user.

Further, the thickness of the light shielding layer 170 may be in the range of 0.5 to 5 mm and the thickness of the front panel 120 may be in the range of 1 to 8 mm.

The thickness and material of the reflection layer 190 and the color of the light shielding layer 170, i.e., the brightness of the printed black layer may be variable by the configuration of the display module 110, the front panel 120, or the transparent film 300, a gap between the display module 110 and the front panel 120, and the like.

That is, the thickness and material of the reflection layer 190 and the color of the light shielding layer 170 may be determined so that colors and reflection effects of the display region and the non-display region of the display apparatus are felt the same as each other, more specifically, the reflectances are the same as each other when viewed from the side of the user.

As the reflection layer 190 and the light shielding layer 170 are overlapped with each other in the non-display region of the display apparatus by the above structure, the heterogeneity between the display region and the non-display region is reduced, such that the boundary between the display region and the non-display region may disappear. As a result, the front surface of the display apparatus including the display region and the non-display region may be viewed to the user as a single layer.

In FIG. 5, although the pattern layer 180, the reflection layer 190, and the light shielding layer 170 are completely overlapped with one another while having the same widths as one another, a part of the pattern layer 180 may not be overlapped with the light shielding layer 170 or the reflection layer 190 or a part of the reflection layer 190 may not be overlapped with the light shielding layer 170 or the pattern layer 180 as necessary.

Meanwhile, the reflection layer 190 may be formed on one surface of the front panel 120 together with the pattern layer 180 or the light shielding layer 170 shown in FIG. 2.

Further, in the structure of the display apparatus shown in FIGS. 2 to 5, an adhesion layer (not shown) may be formed between any two layers, i.e., the transparent film 300 on which the pattern layer 180, the reflection layer 190, and the light shielding layer 170 are formed and the front panel 120.

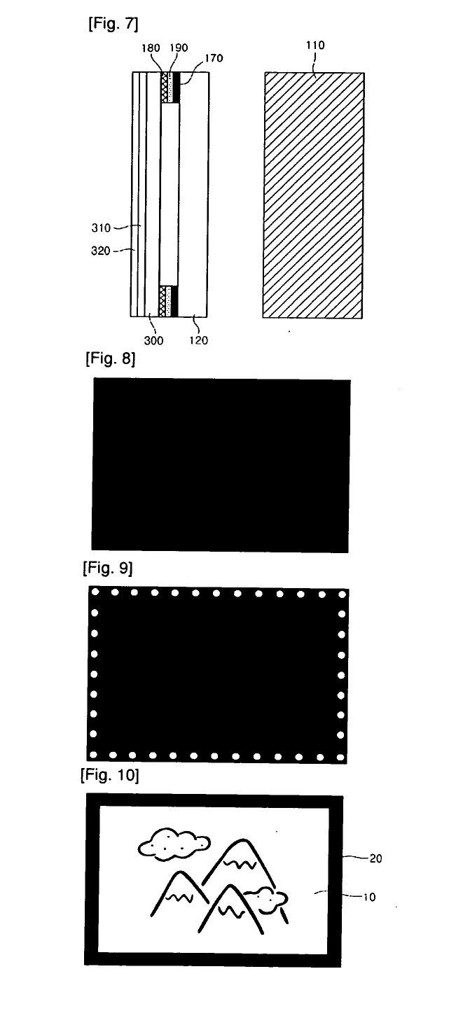

Referring to FIG. 7, a hard coating layer 320 or an anti reflection (AR) layer 310 may be disposed on one surface of the transparent film 300.

FIGS. 8 to 10 are diagrams schematically illustrating exemplary embodiments of a front shape of a display apparatus viewed from the side of a user.

Referring to FIG. 8, when the display apparatus is turned off, as the reflection layer 190 and the light shielding layer 170 is overlapped with each other in the non-display region 20 as described above, the heterogeneity between the display region 10 and the non-display region 20 is reduced, such that the boundary between the display region and the non-display region may disappear. As a result, the front surface of the display apparatus including the display region 10 and the non-display region 20 may be viewed to the user as a single layer.

Meanwhile, as described above, after the display apparatus is turned on, the light source 250 emits light for the stand-by time, such that the pattern 181 formed on the pattern layer 180 may be shown as a predetermined shape and a predetermined color in the non-display region 20.

Referring to FIG. 9, for 4 to 5 seconds after the user turns on the display apparatus, patterns may be shown in the non-display region 20 on the front surface of the display apparatus.

Meanwhile, when the stand-by time of 4 to 5 seconds elapses after the display apparatus is turned on, light emission of the light source 250 ends and thus, light emission of the pattern 181 ends. As a result, the non-display region 20 of the display apparatus shows the black color and an image is displayed in the display region 10 as shown in FIG. 10.

According to the exemplary embodiment of the present invention, the pattern layer is formed in the non-display region of the display apparatus to improve the appearance design of the display apparatus. Further, it is possible to reduce the visual heterogeneity between the display region and the non-display region which the user feels when the power is off by using the reflection layer formed in the non-display region.

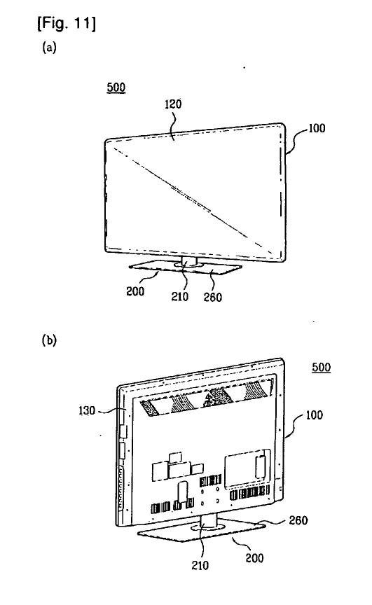

FIG. 11 illustrates a display apparatus according to the present invention. More specifically, FIG. 11 (a) is a front perspective view of the display apparatus and FIG. 11 (b) is a rear perspective view of the display apparatus.

The display apparatus 500 may include a body 100 where an image is displayed and a stand 200 including a neck section 181 supporting a load of the body 100 and a base section 260 distributing the load of the body 100. The body 100 of the display apparatus includes a display panel (not shown) on which an image is displayed therein and the front panel 120 may be mounted on the front surface. A rear surface of the display module 110 is shielded by a rear cover 130.

In display apparatuses which has recently been released, the width of a bezel (a region where no image is displayed) of the front panel 120 tends to gradually decrease and the front panel 120 is often configured by a whole-plate type filter or a glass type.

Since the front panel 120 may difficult to form a boss portion on the rear surface of the front panel 120, a mounting member with the boss portion may be attached to the rear surface of the front panel 120.

The mounting member (not shown) provides a mounting place for directly or indirectly mounting other components on the rear surface of the front panel of a transparent panel type. However, since the front panel 120 is made of a transparent material, the mounting member mounted at the edge of the rear surface, i.e., on the rear surface of the bezel may be observed from the direction of the front surface of the display apparatus.

When the mounting member attached to the rear surface of the transparent front panel 120 is observed, the aesthetic appearance of the display apparatus may be deteriorated. A description regarding the mounting member will be made later again.

The whole-plate-type front panel 120 may be partitioned into a display region where the image displayed on the display panel (not shown) is displayed and a non-display region surrounding the display region where the image is displayed. In addition, the display region should be configured to have light transmittance and the display region and the non-display region may integrally be formed.

The mounting member mounted on the rear surface of the non-display region may be observed from the direction of the front surface. Of course, painting or an attachment film for preventing light from being transmitted may be added to the non-display region of the front panel 120, but a possibility that the mounting member will be observed from the direction of the front surface of the front panel 120 cannot completely be removed.

In particular, since the mounting member may be fixed to the rear surface of the non-display region of the front panel 120 by using an adhesive or a double-sided tape, a method for preventing the mounting member from being observed from the direction of the front surface by adding the painting or attachment film to the front surface or the rear surface of the non-display region of the front panel 120 made of the transparent material may be inappropriate.

The mounting member may be mounted primarily on the non-display region of the rear surface of the front panel 120.

Therefore, in order to fundamentally solve the problem, the present invention provides a display apparatus that includes a display module with a display panel on which an image is displayed, a front panel 120 that is provided on a front surface of the display module and includes a display region where an image displayed on the display panel is displayed and a horizontal direction or vertical direction non-display region surrounding the display region, a rear cover 130 shielding a rear surface of the display module, and a plurality of mounting members (not shown) which are spaced and mounted onto the rear surface of the non-display region of the front panel 120 to be fastened with at least one of the display module and the rear cover 130, wherein the width of at least one non-display region of the horizontal direction and vertical direction non-display regions of the front panel 120 increases to the direction of a rear surface of the front panel.

The reason that the width of at least one non-display region of the horizontal direction and vertical direction non-display regions of the front panel 120 increases to the direction of the rear surface of the front panel 120 is to prevent the mounting member attached to the rear surface of the non-display region of the front panel 120 from being observed from the direction of the front surface of the display apparatus through an optical structure of the non-display region of the front panel 120.

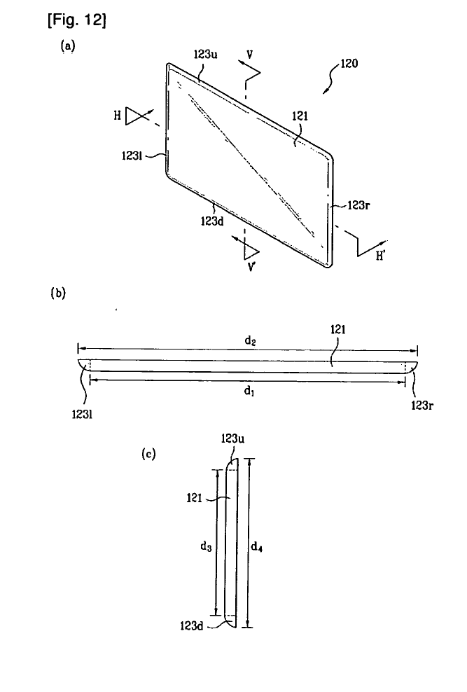

Referring to FIG. 12, the structure of the front panel 120 will be described.

FIG. 12 is a perspective view and a cross-sectional view of a front panel 120 of a display apparatus according to an exemplary embodiment of the present invention. More specifically, FIG. 12 (a) is a perspective view in the direction of the front surface of the front panel 120, FIG. 12 (b) is an axial-direction cross-sectional view of the front panel 120 in taken along line H-H, and FIG. 12 (c) is an axial-direction cross-sectional view taken along line V-V.

The front panel 120 shown in FIG. 12 may be provided as for example, glass made of a light transmissive material or a whole plate-type of a compression and injection molded light transmissive material.

As described above, the width of at least one non-display region of the horizontal and vertical non-display regions of the front panel 120 may have a shape to increase toward the rear surface of the front panel 120.

The front panel 120 shown in FIG. 12 may include horizontal direction non-display regions 123l and 123r and a pair of vertical direction non-display regions 123u and 123d in upper and lower parts thereof.

As shown in FIGS. 12 (b) and 12 (c), the widths of the non-display regions 123l, 123r, 123u, and 123d may have a shape to increase toward the rear surface of the front panel 120.

That is, since the periphery of the front panel 120 has an oblique slope, a horizontal direction width d1 of the front surface of the front panel 120 may be smaller than a horizontal direction width d2 of the rear surface of the front panel 120 and a vertical-direction width d3 of the front surface of the front panel 120 may be smaller than a vertical direction width d4 of the rear surface of the front panel 120.

Besides, the shape in which the widths of the non-display regions 123l, 123r, 123u, and 123d increase toward the rear surface of the front panel 120 may variously be modified. For example, the non-display regions may be rounded to be inclined in a pre-determined direction or cut to configure a plane inclined in a predetermined direction.

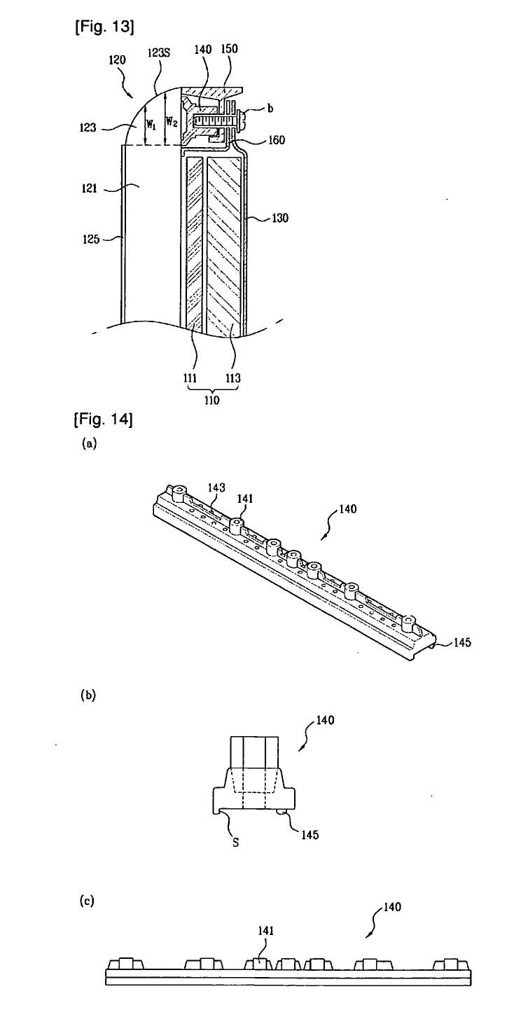

FIG. 13 is a cross-sectional view of a display apparatus according to the present invention. Specifically, the left side of the FIG. 13 is the front direction of the display apparatus and the right side of FIG. 13 is the rear direction of the display apparatus.

The front panel 120 is provided on a front surface of a display panel 111 configuring a display module 110. Further, the display module 110 may be provided with a backlight unit 113 on a rear surface of the display panel 111.

The front panel 120 may be made of a transparent material to transmit an image displayed on the display panel 111 in the direction of the front surface of the display apparatus.

A non-display region 123 is integrally configured on the periphery of a display region 121 of the front panel 120 and the non-display region 123 has a shape in which its cross-sectional width w increases toward the rear surface of the front panel 120.

In the exemplary embodiment shown in FIG. 13, in the case of the width of the non-display region 123, the width w1 of a part positioned close to the front surface of the front panel is smaller than the width w2 of a part positioned close to the rear surface of the front panel. In the exemplary embodiment shown in FIG. 13, the cross-sectional width w of the non-display region 123 may increase toward the rear surface and an outer surface 123S of the non-display region 123 may have a gentle curved shape.

A mounting member 140 is fixed onto the rear surface of the non-display region 123 of the front panel 120. The mounting member 140 serves to provide a mounting place for mounting other components on the flat-type front panel 120. The mounting member 140 may be provided with at least one boss portion. The plurality of mounting members 140 may be spaced and mounted on the rear surface of the non-display region of the front panel 120.

A middle housing for shielding the side of the display apparatus may be mounted on the mounting member 140. The middle housing may be fastened to the boss portion provided in the mounting member 140.

In addition, the mounting member 140 may further include a supporter 160 metallically extrusion molded for the purpose of reinforcing the rigidity of the display apparatus, shielding EMI, or the like. The supporter 160 may be fastened to the mounting member 140 together with a rear cover.

The supporter 160 may be attached to the rear surface of the front panel 120 by using a double-sided tape, and the like.

The backlight unit 113 performing a lighting function may be provided on the rear surface of the display panel 111.

FIG. 14 illustrates one example of the mounting member 140 of the display apparatus according to the present invention. More specifically, FIG. 14 (a) is a perspective view of the mounting member 140, FIG. 14 (b) is a cross-sectional view of the mounting member 140, and FIG. 14 (c) is a side view of the mounting member 140.

The mounting member 140 may include at lest one of a plurality of boss portions in a length direction thereof. In the case in which the front panel 120 is provided as the glass type or the whole plate-type filter, the mounting member 140 may be attached by using an adhesive, and the like and a discharge hole 143 may be formed at the boss portion 141 to prevent the adhesive from spreading to other regions and discharge a remaining adhesive upwards.

Further, the bottom of the mounting member 140 as a place in which the adhesive is filled may be provided with ribs 145 for forming a predetermined space s between the bottom of the mounting member 140 and the rear surface of the non-display region of the front panel 120.

The ribs 145 serves to separate the bottom of the mounting member 140 from the front panel 120 and separates the bottom of the mounting member 140 from the front panel 120 in order to provide the space s in which the adhesive is filled.

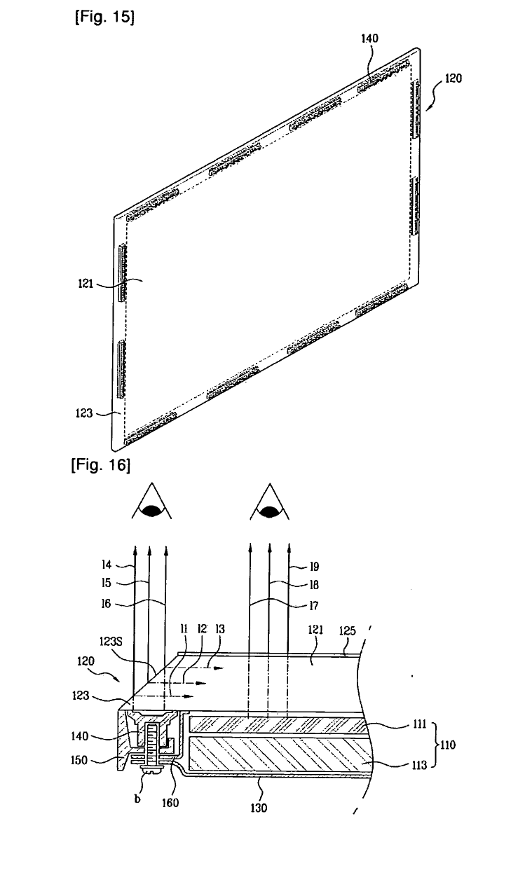

FIG. 15 illustrates a state in which the mounting member 140 is mounted on the front panel 120 of the display apparatus according to the present invention. The plurality of mounting members 140 may be separated from each other in the non-display region 123 of the front panel 120 or in the length direction of the rear surface of the periphery as described above. Therefore, the number of the mounting members 140 may increase or decrease depending on the size of the display apparatus.

As described above, the front panel 120 is partitioned into the display region which is made of a light transmissive material and where the image displayed on the display panel is displayed and the non-display region surrounding the periphery of the display region. In the case in which the mounting member 140 is attached to the rear surface of the non-display region of the front panel 120, when the mounting member 140 is observed from the direction of the front surface of the display apparatus, a unification integral effect and aesthetic effect of the appearance of the display apparatus may be deteriorated. Of course, paint or a film made of a material through which light is not transmitted may be attached, but the effect may not be big.

Therefore, the display apparatus according to the present invention adopts a method of configuring the front panel 120 having the shape in which the width of at least one non-display region of the horizontal direction and vertical direction non-display regions of the front panel 120 increases toward the rear surface of the front panel 120. For example, an object positioned on the rear surface of the non-display region on which the mounting member 140 is mounted is prevented from being optically observed from the direction of the front surface of the front panel 120 by using a method of configuring the horizontal direction or vertical direction periphery or at least one periphery in the non-display region of the front panel 120 by an inclined curve or an inclined plane.

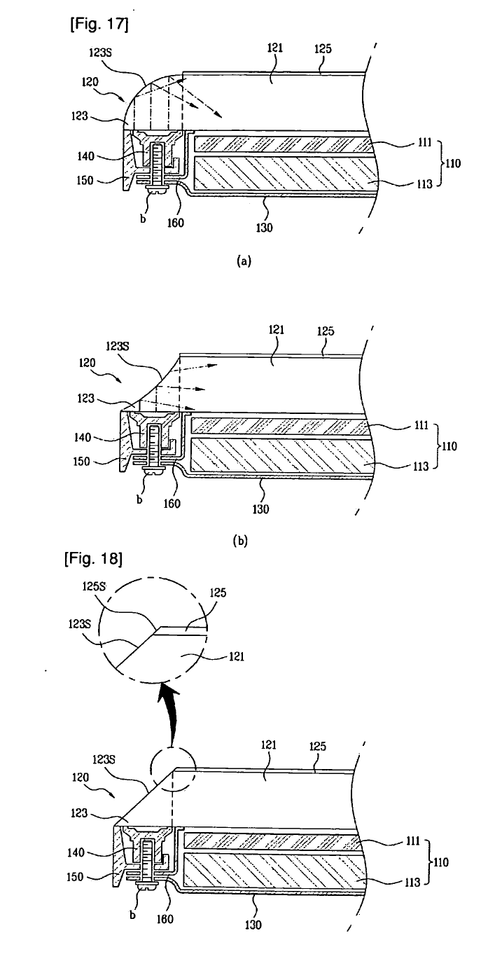

Hereinafter, referring to FIGS. 16 and 17, an optical effect in the case of configuring the front panel 120 having the shape in which the width of at least one non-display region of the horizontal direction and vertical direction non-display regions of the front panel 120 increases toward the rear surface of the front panel 120 will be examined.

FIG. 16 illustrates one example of a cross-sectional view of a part adjacent to the periphery of the display apparatus according to the present invention.

As shown in FIG. 16, the non-display region is provided on the periphery of the front panel 120. The non-display region has a shape in which the width of the non-display region increases toward the rear surface of the front panel 120 as shown in FIG. 16. The mounting member 140 is fixed to the rear surface of the non-display region.

An observer who observes the display apparatus from the direction of the front of the front panel 120 should be able to observe light emitted from the mounting member 140 in order to observe the mounting member 140. However, when light 11, 12, or 13 emitted from the mounting member 140 is full-reflected on an internal interface of the outer surface 123S of the non-display region of the front panel 120, the observer positioned in front of the front panel 12 may not observe the full-reflected light 11, 12, and 13.

An external observer observes only light 14,15, and 16 emitted from the external surface 123S of the non-display region to reach the observer, the external observer does not observe the mounting member 140.

On the contrary, below the display region of the front panel 120, light 17,18, or 19 including the image displayed on the display panel penetrates the front panel 120 and reaches the observer, which may observe the image displayed on the display panel 111.

By such a method, it is possible to prevent the mounting member 140 fixed by attachment onto the rear surface of the front panel 120 from being observed from the direction of the front surface of the display apparatus.

That is, it is possible to prevent the mounting member 140 positioned on the rear surface of the front panel 120 from being observed by arbitrarily inducing an optical illusion phenomenon. Since the supporter 160 fastened together with the rear cover may be observed on the rear surface of the non-display region of the front panel 2120 in addition to the mounting member 140, the shape of the periphery or edge of the front panel 120 may be configured as described above by preventing it.

FIG. 17 illustrates another example of a cross-sectional view of a part adjacent to the periphery of the display apparatus according to the present invention. A duplicated description with the description referring to FIG. 16 will be omitted.

In the exemplary embodiment shown in FIG. 17, the case in which the non-display region, i.e., the periphery of the front panel 120 is rounded by the method of configuring the front panel 120 in the shape in which the width of at least one non-display region of the horizontal direction and vertical direction non-display regions of the front panel 120 increases toward the rear surface of the front panel 120 is shown.

That is, a case in which the outer surface 123S of the non-display region of the front panel 120 is convex outwardly (FIG. 17 (a)) and a case in which the outer surface 123S is concave inwardly (FIG. 17 (b)) are shown.

In the exemplary embodiment shown in FIG. 16, the outer surface of the non-display region has an inclined plane, but in the exemplary embodiment shown in FIG. 17, the outer surface may have a curved surface.

In the case in which the outer surface 123S of the non-display region of the front panel 120 is configured by the curved surface, an angle at which the light provided from the mounting member 140 is incident into the outer surface 123S of the non-display region may selectively be adjusted to a total reflection angle or less.

The outer surface 123S of the non-display region of the front panel 120 may be curved to be convex outwardly in order to reduce an incident angle of light incident outwardly on the outer surface 123S of the non-display region of the front panel 120 and the outer surface 123S of the non-display region of the front panel 120 may be curved to be concave inwardly in order to reduce an incident angle of light incident inwardly on the outer surface 123S of the non-display region of the front panel 120, that is, the vicinity of a boundary with the vicinity of the display region.

Therefore, by considering positions of components disposed on the rear surface of the non-display region of the front panel 120, the width of the non-display region increases toward the rear surface of the front panel 120 and the outer surface 123S of the non-display region of the front panel 120 may be formed to be convex or concave.

FIG. 18 is another example of a cross-sectional view in the vicinity of a periphery of a display apparatus according to the present invention. A duplicated description described with reference to FIGS. 16 and 17 will be omitted.

In the exemplary embodiment shown in FIG. 18, an optical film 125 is also attached onto the front surface of the front panel 120 similarly as the exemplary embodiment shown in FIGS. 16 and 17. The optical film 125 may be provided to prevent a scratch of the front panel 120 or partition the display region by printing, and the like or prevent or reduce reflection.

A case in which the optical film 125 is a low-reflection film for preventing diffused reflection of light will be assumed and described. The low-reflection film may be attached to the entirety of the front panel 120, but when the width of the horizontal-direction or vertical-direction non-display region is changed to the thickness direction of the front panel 120, the low-reflection film is extended and bent up to the later surface 123S of the non-display region to be not easy to attach, as a result, the low-reflection film may be attached to only a region corresponding to the display region 121 of the front panel 120.

In the case where the low-reflection film is attached to only the region corresponding to the display region 121 of the front panel 120, an end 125s of the low-reflection may easily be peeled or separated by external stimulus. That is, of the end 125s of the low-reflection film is physically stimulated with repetition by user s carelessness or a long-time use, a failure in an attachment state on the entire surface of the front panel 120 may occur.

Therefore, in order to firm the attachment state, the end 125s may be configured to have a slope corresponding to a gradient on the interface between the display region and the non-display region of the front panel 120.

That is, the low-reflection film may be attached to the display region 121 of the front panel 120 so that an end 125c of the low-reflection film is formed on the same surface as the lateral surface of the front panel 120, i.e., the lateral surface 123S of the non-display region 123 as shown in the enlarged diagram of FIG. 18.

In the exemplary embodiment shown in FIG. 18, the lateral surface 1235 of the non-display region 123 is a horizontal plane, but the lateral surface 123S of the non-display region 123 may be the curved surface like the exemplary embodiment shown in FIG. 17. The lateral surface of the end 125c of the low-reflection film may be formed on the same curved surface as the lateral surface of the non-display region.

In the display apparatus according to the present invention, the front panel may be configured by a whole plate type. It is possible to improve completeness of the overall appearance by preventing the components mounted on the rear surface of the non-display region where the image is not displayed on the whole plate-type front panel from being observed from the outside and the non-display region where the image is not displayed on the whole plate-type front panel may be disabled to be viewed or enabled to be smaller than the actual size by an illusion effect.

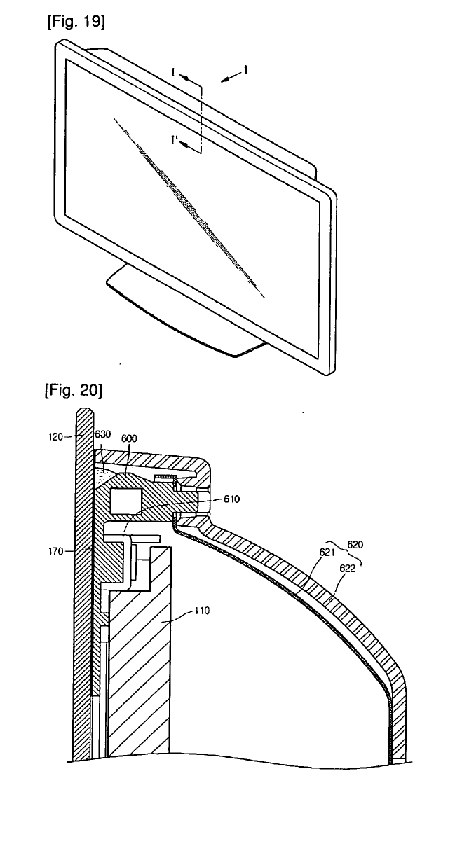

Hereinafter, referring to FIGS. 19 to 22, a configuration of a display apparatus according to yet another exemplary embodiment of the present invention will be described.

FIG. 19 is an external perspective view of a display apparatus according to an exemplary embodiment of the present invention and FIG. 20 is a cross-sectional view taken along line I-I of FIG. 19.

Referring to FIGS. 19 and 20, the display apparatus 1 may includes a display module 110 outputting an image, a front panel 120 protecting a front surface of the display module 110, a frame 600 having a front surface closely coupled to the front panel 120 and a rear surface to which the display module 110 is fixed, a bracket 610 connecting the display module 110 with the frame 600, and a back cover 620 coupled to the rear surface of the front panel 120 to cover and protect the display module 110.

Further, a light shielding layer 170 may be formed on the periphery of the rear surface of the front panel 120 and a sealing member 630, i.e., silant is applied onto the upper part of the front surface of the frame 600 to prevent dust from being introduced a space between the frame 600 and the front panel 120.

Meanwhile, the frame 600 may be surrounded on the periphery of the rear surface of the front panel 120. For example, a plurality of frames 600 may be attached to a region spaced apart from the edge of the front panel 120 by a predetermined gap. In addition, the ends of the adjacent frames 600 may be closely connected to each other. The bracket 610 may be installed at a connection portion of the ends.

The periphery of the front surface of the back cover 620 covering and protecting the display module 110 is closely attached to the frame 600. The back cover 620 may include an inner housing 621 and an outer housing 622 covering the inner housing 621, which are made of a conductive material.

However, the back cover 620 may not necessarily be constituted by two and may be constituted by one conductive cover.

As shown in FIG. 20, in the display apparatus according to the exemplary embodiment of the present invention, an outer periphery of the front panel 120 may be exposed to the outside.

For example, when viewed from the front of the display apparatus 1, top, bottom, right, and left peripheries of the front panel 120 may be exposed to the outside without being covered by other structures such as the back cover 620, and the like.

As a result, the entirety of the light shielding layer 170 formed on the periphery of the rear surface of the front panel 120 may be exposed and viewed to the outside through the front panel 120.

Further, when viewed from the rear of the display apparatus 1, the top, bottom, right, and left peripheries of the front panel 120 may be exposed to the outside without being covered by other structures.

In the above description, the display apparatus according to the exemplary embodiment of the present invention is described by using the case in which the top, bottom, right, and left peripheries of the front panel 120 are all exposed to the outside as an example, but the present invention is not limited thereto.

For example, only parts of the top, bottom, right, and left peripheries of the front panel 120 may be exposed to the outside. Alternatively, only the periphery of the front surface of the front panel 120 may be exposed to the outside.

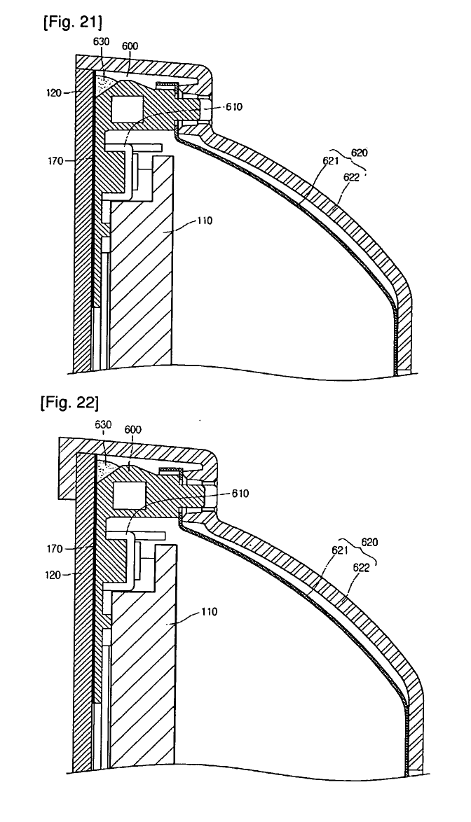

Referring to FIG. 21, when viewed from the front of the display apparatus 1, the periphery of the front surface of the front panel 120 may be exposed to the outside without being covered by other structures.

However, the peripheries of the rear surface of the front panel 120 are covered by the back cover 620, such that when viewed from the rear of the display apparatus, the front panel 120 may not be exposed to the outside.

In the above description, although the periphery of the rear surface of the front panel 120 is covered by the back cover 620, the present invention is not limited thereto and the periphery of the rear surface of the front panel 120 may be covered by the frame 600 covering the lateral surface of the display module 110 or an additional side cover (not shown).

Even as shown in FIG. 21, when viewed from the front of the display apparatus, the entire light shielding layer 170 may be exposed and viewed to the outside through the front panel 120.

According to yet another exemplary embodiment of the present invention, a part of the periphery of the front panel 120 may be covered by other structures in front thereof.

Referring to FIG. 22, a part adjacent the end of the periphery of the front surface of the front panel 120 is covered by the back cover 620, such that when viewed from the front of the display apparatus, the front panel may not be exposed to the outside.

In the above description, although a part of the periphery of the front surface of the front panel 120 is covered by the back cover 620, the present invention is not limited thereto and a part of the periphery of the rear surface of the front panel 120 may be covered by the frame 600 covering the lateral surface of the display module 110 or an additional side cover (not shown).

In this case, when viewed from the front of the display apparatus, a part adjacent to the end of the light shielding layer 170 may not be exposed to the outside through the front panel 120.

However, even as shown in FIG. 22, the size of the region of the light shielding layer 170 exposed to the outside may be larger than the rest region which is not exposed to the outside.

Although preferred embodiments of the present invention have been illustrated and described, the present invention is not limited to the above-mentioned embodiments and various modified embodiments can be available by those skilled in the art without the scope of the appended claims of the present invention. In addition, these modified embodiments should not be appreciated separately from technical spirits or prospects.

1. A display apparatus, comprising:
a display module;
a front panel disposed on a front surface of the display module;
a light shielding layer disposed on the outer peripheral area of the front panel;
a pattern layer of which at least a part is overlapped with the light shielding layer; and
a light source,
wherein a pattern formed on the pattern layer emits light by using light provided from the light source.

2. The display apparatus of claim 1, further comprising:
a transparent film disposed on a front surface of the front panel, wherein the pattern layer is disposed between the front panel and the transparent film.

3. The display apparatus of claim 1, further comprising:
a transparent film disposed on the front surface of the front panel,
wherein the pattern layer is disposed on one surface of the transparent film.

4. The display apparatus of claim 3, wherein the pattern layer is formed by printing the pattern on one surface of the transparent film.

5. The display apparatus of claim 1, wherein the pattern is formed at a position overlapped with the light shielding layer.

6. The display apparatus of claim 1, wherein the display apparatus includes a display region where an image is displayed and a non-display region where no image is displayed and the pattern and the light shielding layer are formed in the non-display region.

7. The display apparatus of claim 1, wherein the pattern emits light for a predetermined time after power is supplied to the display apparatus.

8. The display apparatus of claim 1, wherein the light source emits light for a predetermined time after power is supplied to the display apparatus.

9. The display apparatus of claim 1, wherein the light source is disposed on a lateral surface of the pattern layer.

10. The display apparatus of claim 1, wherein the light shielding layer is a black layer printed on the outer peripheral area.

11. The display apparatus of claim 1, further comprising a reflection layer formed overlapped with the light shielding layer.

12. The display apparatus of claim 11, wherein the reflection layer is formed by depositing Nickel (Ni) or aluminum (Al).

13. The display apparatus of claim 1, wherein the front panel is partitioned into a display region where an image is displayed and horizontal-direction and vertical-direction non-display regions surrounding the display region,
the width of at least one non-display region of the horizontal-direction and vertical-direction non-display regions of the front panel increases toward a rear surface of the front panel.

14. The display apparatus of claim 13, further comprising:
a rear cover shielding the rear of the display module; and
a plurality of mounting members spaced and fixed onto a rear surface of the non-display region of the front panel and fastened with at least one of the display module and the rear cover.

15. The display apparatus of claim 14, wherein the plurality of mounting members include at least one boss portion and are spaced and attached to the rear surface of the non-display region of the front panel in a length direction.

16. The display apparatus of claim 13, wherein a lateral surface of the non-display region has an inclined curved or planar shape.

17. The display apparatus of claim 13, further comprising:
an optical film attached on a front surface of the display region of the front panel,
wherein the lateral surface of the front panel has the inclined curved or planar shape and the periphery of the optical film is inclined in the same direction as the lateral surface of the front panel.

18. A display apparatus, comprising:
a display module;
a front panel disposed on a front surface of the display module;
a transparent film disposed on a front surface of the front panel;
a light shielding layer formed on the outer peripheral area of the transparent film;
a pattern layer formed on one surface of the transparent film and including a pattern formed at a position overlapped with the light shielding layer; and
a light source,
wherein the pattern formed on the pattern layer emits light by using light provided from the light source.

19. The display apparatus of claim 18, further comprising:
a reflection layer disposed between the light shielding layer and the pattern layer.

20. The display apparatus of claim 18, wherein the front panel is partitioned into a display region where an image is displayed and horizontal-direction and vertical-direction non-display regions surrounding the display region,
the width of at least one non-display region of the horizontal-direction and vertical-direction non-display regions of the front panel increases toward a rear surface of the front panel.
